(19) United States
(12) Patent Application Publication
(10) Pub. No.: US 2021/0276302 A1
(43) Pub. Date: Sep. 9, 2021

(54) METHOD OF MANUFACTURING SOUND ABSORBING MATERIAL FOR VEHICLE

(71) Applicants: Hyundai Motor Company, Seoul (KR); Kia Motors Corporation, Seoul (KR); HADO FNC CO., LTD., Pocheon (KR); Hyundai Synthetic CO., LTD., Ansan (KR)

(72) Inventors: Seong-Je Kim, Seongnam (KR); Seung-Hyun Won, Gunpo (KR); Keun-Young Kim, Suwon (KR); Ji-Wan Kim, Hwaseong (KR); Jung-Wook Lee, Bucheon (KR); Tae-Yoon Kim, Daejeon (KR); Min-Seok Seo, Incheon (KR); Jong-Eun Ha, Seoul (KR); Young-Su Kim, Uijeongbu (KR); Hyun-Ho Shin, Ansan (KR); Si-Yoon Kim, Hwaseong (KR); Joung-Jun Cho, Siheung (KR)

(21) Appl. No.: 17/021,719

(22) Filed: Sep. 15, 2020

(30) Foreign Application Priority Data
Mar. 3, 2020 (KR) 10-2020-0026499

(51) Int. Cl. B32B 5/06; B32B 5/02; B32B 5/08

(52) U.S. Cl. CPC B32B 5/06; B32B 5/022; B32B 2605/00; B32B 2262/0284; B32B 2307/102; B32B 5/08

(57) ABSTRACT

Disclosed is a method of manufacturing a sound absorbing material for a vehicle, which may include: (a) preparing a mixed fiber including an amount of about 55 to 75 wt % of microfiber polyethylene terephthalate staple fiber having fineness of about 0.3 to 0.7 denier, an amount of about 20 to 40 wt % of low-melt polyethylene terephthalate staple fiber having a fineness of about 1 to 3 denier and a melting point of about 100 to 110° C., and an amount of about 1 to 20 wt % of hollow staple fiber having a fineness of about 13 to 17 denier and a diameter of about 38 to 43 μm, based on the total weight of the mixed fiber. The method may suitably further comprise (b) forming a plurality of webs comprising the mixed fiber; (c) forming a web layer comprising a plurality of webs; and (d) forming non-woven felt comprising the web layer.

### CROSS-REFERENCE TO RELATED APPLICATION

This application claims under 35 U.S.C. § 119(a) the benefit of Korean Patent Application No. 10-2020-0026499, filed on Mar. 3, 2020, the entire contents of which are incorporated herein by reference.

### TECHNICAL FIELD

The present invention relates to a method of manufacturing a sound absorbing material for a vehicle. The method of manufacturing a sound absorbing material for a vehicle may be applied to an interior material or an exterior material of the vehicle and have excellent sound absorbing performance.

### BACKGROUND

With environment-friendly and human-friendly industry trends, a material used in a transportation device such as vehicles, trains, or airplanes requires environment friendliness, light weight, and high durability. Generally, a sound absorbing material that is widely used as a sound absorbing material for a vehicle includes glass wool, polyurethane foam, foamed aluminum, and the like. However, the glass wool is harmful to the human body and cannot recycled, the polyurethane foam may need high manufacturing cost and may not have sufficient water resistance, and the foamed aluminum may have problems in cost and durability. As such, these materials may have limitations on the development of a lightweight sound absorbing material made of fiber.

FIG. 1 illustrates a melt-blown manufacturing method that is a conventional method of manufacturing a sound absorbing material for an vehicle. The melt-blown method refers to a method of directly spinning fiber to manufacture a non-woven fabric. As shown in FIG. 1, after polymer resin and an additive are put into a hopper 1, the polymer resin and the additive are mixed with each other through a screw extruder 3, and the molten resin mixture is sent to a melt-blown die 5. As soon as the sent resin mixture is discharged from a nozzle in which a plurality of holes is arranged, the mixture is compressed by high-temperature and high-velocity air ejected from a slit of an air jet 7. At this time, cooling fluid is supplied to both sides of a slit outlet through which the high-temperature and high-velocity air is ejected, thus cooling the discharged resin mixture. Subsequently, the compressed resin mixture is deposited on a collection drum 9, thus manufacturing the non-woven fabric.

According to the melt-blown manufacturing method, the non-woven fabric is manufactured by directly compressing and spinning fiber. However, an initial equipment investment cost is high, a production cost for a process is high due to precision equipment, and productivity is very low because a production speed is slow. Thus, the cost of a product is inevitably increased. Furthermore, since a material manufactured by the melt-blown manufacturing method is very weak in web strength, there are many limitations on using the material alone. Thus, this material should be mixed with a web or staple fiber by a spunbond method.

### SUMMARY

In preferred aspects, provided is a method of manufacturing a sound absorbing material for a vehicle. The method may provide improved productivity and impart heat-resistant performance and tensile strength to a sound absorbing material for a manufactured compared to a common melt-blown manufacturing method.

In an aspect, provided is a method of manufacturing a sound absorbing material for a vehicle.

In a preferred aspect, provided is a method of manufacturing a sound absorbing material for a vehicle that may comprise preparing a mixed fiber including an amount of about 55 to 75 wt % of a microfiber polyethylene terephthalate (PET) staple fiber that has a fineness of about 0.3 to 0.7 denier (D), an amount of about 20 to 40 wt % of a low-melt polyethylene terephthalate (LM PET) staple fiber that has a fineness of about 1 to 3 denier and a melting point of about 100 to 110° C., and an amount of about 1 to 20 wt % of a hollow staple fiber that has a fineness of about 13 to 17 denier and a diameter of about 38 to 43 μm, based on the total weight of the mixed fiber. In certain preferred aspects, the method may further comprise preparing a plurality of webs a comprising the mixed fiber such as by carding the mixed fiber. In certain preferred aspects, the method may further comprise forming a web layer comprising the plurality of webs such as by stacking a plurality of webs. In yet additional preferred aspects, the method may further comprise forming non-woven felt comprising the web layer such as by needle punching the web layer.

In a further preferred aspect, a method is provided that may include steps of: (a) preparing a mixed fiber including an amount of about 55 to 75 wt % of a microfiber polyethylene terephthalate (PET) staple fiber that has a fineness of about 0.3 to 0.7 denier (D), an amount of about 20 to 40 wt % of a low-melt polyethylene terephthalate (LM PET) staple fiber that has a fineness of about 1 to 3 denier and a melting point of about 100 to 110° C., and an amount of about 1 to 20 wt % of a hollow staple fiber that has a fineness of about 13 to 17 denier and a diameter of about 38 to 43 μm, based on the total weight of the mixed fiber; (b) forming a plurality of webs comprising the mixed fiber such as by carding the mixed fiber; (c) forming a web layer comprising the plurality of webs such as by stacking a plurality of webs; and (d) forming non-woven felt comprising the web layer such as by needle punching the web layer. The term “low-melt polyethylene terephthalate fiber” as used herein refers to a polyethylene terephthalate fiber that has a low-melting point or low-melting temperature compared to a melting temperature of a regular type polyethylene terephthalate fiber or polyethylene terephthalate resin, for example, due to modification in chemical properties or composition of that fiber. For example, the low-melt point polyethylene terephthalate staple fiber may have a melting temperature lower, by at least about 10° C., 20° C., 30° C., 40° C., 50° C., 60° C., 70° C., 80° C., 90° C., 100° C., or 150° C. than that of the regular polyethylene terephthalate staple fiber. In a certain preferred embodiment, the low-melt polyethylene terephthalate staple fiber may suitably have a melting point of about 150° C. or less. One preferred low-melting point polyester resin may have a melting point in a range of from 100° C. to 110° C.

The term “hollow fiber” as used herein refers to a fiber that may have a structure that has an inner empty space, such as channel or hole, surrounded by a fiber material or other components such as filler surrounding the inner space. Preferred hollow fiber may include a core as a form of hole or channel without a filler material or other components.

A mix weight ratio of the microfiber polyethylene terephthalate (PET), the low-melt polyethylene terephthalate (LM PET), and the hollow staple fiber may be about 10:5:1 to 15:7:1.

A melting point of the mixed fiber may range from about 240° C. to about 250° C.

The step (c) may include a first needle punching and a second needle punching, and a pressure in the second needle punching may be greater than a pressure in the first needle punching.

A stroke number of the needle punching may range from about 5 ea/cm² to about 20 ea/cm² (PPSC) (punching per square centimetre).

According to various exemplary embodiments of the present invention, a sound absorbing material for an vehicle having excellent in sound absorbing performance, heat resistance, and tensile strength may be manufactured by applying a carding-needle punching process to a polyethylene terephthalate (PET) material.

Further provided are materials included non-woven materials (e.g. non-woven felts) that are obtained or obtainable by the methods disclosed herein.

Still further provided are vehicles that comprise non-woven materials (e.g. non-woven felts) that are obtained or obtainable by the methods disclosed herein.

### BRIEF DESCRIPTION OF THE DRAWINGS

FIG. 1 illustrates a melt-blown manufacturing method that is a conventional method of manufacturing a sound absorbing material for a vehicle.

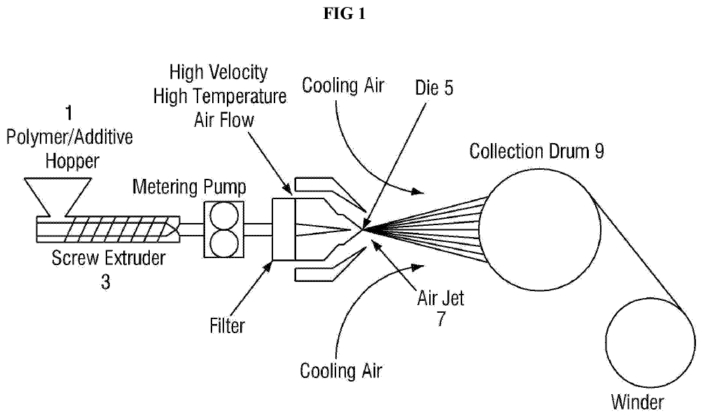

FIG. 2 schematically illustrates an exemplary method of manufacturing an exemplary sound absorbing material for a vehicle according to an exemplary embodiment of the present invention.

FIG. 3 illustrates the result values of sound absorption of example 1 and comparative example 2 according to a frequency.

FIG. 4 illustrates the result values of sound absorption of comparative example 1 and comparative example 2 according to a frequency.

FIG. 5A illustrates a real photograph of comparative example 2, and FIG. 5B illustrates a real photograph of example 1.

FIG. 6 is a photograph capturing a process of evaluating heat resistance of example 1 and comparative example 2.

FIG. 7A illustrates a section of example 1, and FIG. 7B illustrates a section of comparative example 2.

FIG. 8 is a graph illustrating the result of Table 8.

FIG. 9A is a photograph illustrating an vehicle component to which a sound absorbing material of example 1 is actually mounted, and FIG. 9B is a photograph illustrating an vehicle component to which a sound absorbing material of comparative example 2 is actually mounted.

### DETAILED DESCRIPTION

Hereinafter, the present invention will be described in detail. However, the present invention is not limited or restricted by exemplary embodiments. The objects and effects of the present invention may be naturally understood or more apparent from the following description, and are not limited by the following description. Further, in the description of the present invention, when it is determined that the related art of the present invention unnecessarily makes the gist of the present invention obscure, a detailed description thereof will be omitted.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

When a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

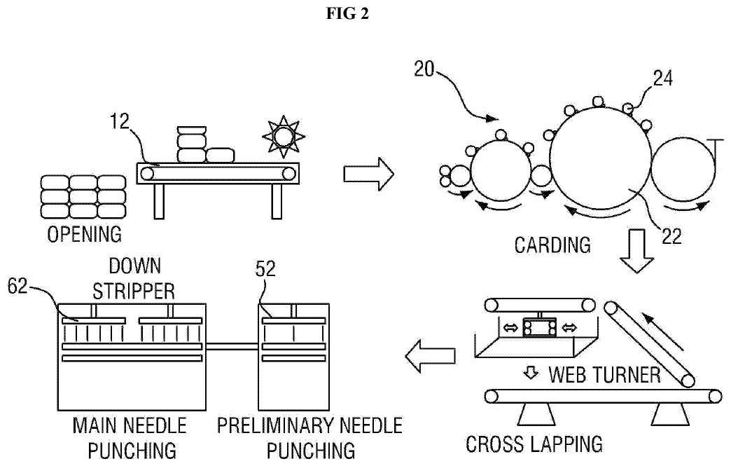

FIG. 2 schematically illustrates an exemplary method of manufacturing an exemplary sound absorbing material for an vehicle according to an exemplary embodiment of the present invention. For example, as shown FIG. 2, the method of the present invention may include (a) a step of preparing a mixed fiber including an amount of about 55 to 75 wt % of microfiber polyethylene terephthalate (PET) staple fiber having a fineness of about 0.3 to 0.7 denier (D), an amount of about 20 to 40 wt % of low-melt polyethylene terephthalate (LM PET) staple fiber having a fineness of about 1 to 3 denier and the melting point of about 100 to 110° C., and an amount of about 1 to 20 wt % of hollow staple fiber having a fineness of about 13 to 17 denier and the diameter of about 38 to 43 μm, based on the total weight of the mixed fiber, (b) a step of forming a plurality of webs by carding the mixed fiber, (c) a step of forming a web layer by stacking a plurality of webs, and (d) a step of forming non-woven felt by needle punching the web layer.

In step (a), the microfiber polyethylene terephthalate (PET) staple fiber having the fineness of about 0.3 to 0.7 denier (D), the low-melt polyethylene terephthalate (LM PET) staple fiber having the fineness of about 1 to 3 denier and the melting point of about 100 to 110° C., and the hollow staple fiber having the fineness of about 13 to 17 denier and the diameter of about 38 to 43 μm may be supplied and then mixed. A predetermined weight of fiber may be supplied by a belt weigher 12. By a basis weight device included in the belt weigher, each staple fiber may be adjusted to a predetermined weight range and then supplied to a subsequent carding machine 20.

The above-described microfiber polyethylene terephthalate (PET) may have a less thickness than a thickness of the normal polyethylene terephthalate (PET). For example, the normal polyethylene terephthalate (PET) may have the fineness of about 6 to 7 denier, whereas the microfiber polyethylene terephthalate (PET) of the present invention may have the fineness of about 0.3 to 0.7 denier, for example, about 0.5 denier. In the case of using the normal polyethylene terephthalate (PET) that is relatively thicker when manufacturing the sound absorbing material for the vehicle, the sound absorbing performance may be degraded. Thus, it is preferable to use the relatively thin microfiber polyethylene terephthalate (PET).

The content of the above-described microfiber polyethylene terephthalate (PET) may be about 55 to 75 wt %, about 60 to 70 wt %, or particularly of about 63 to 67 wt %, for example, about 65 wt % based on the total weight of the mixed fiber of 100 wt %. When the content is out of this range, the sound absorbing performance may be degraded in a low-frequency region, particularly at the region of 1000 to 2000 Hz.

Preferably, the above-described low melt polyethylene terephthalate (Low melt PET, and hereinafter, the low melt will also be referred to as low viscosity) may have a melting point at a temperature less than that of the normal polyethylene terephthalate (PET) fiber. Because it has the melting point of about 100 to 110° C., formability may be imparted in carrying out the method described herein.

The low viscosity polyethylene terephthalate (LM PET) may have the fineness of about 1 to 3 denier, for example, about 2 denier, and may preferably be a staple fiber that is thinner than the normal polyethylene terephthalate (PET) fiber. The content of the low-melt polyethylene terephthalate (LM PET) may be about 20 to 40 wt %, about 25 to 35 wt %, or particularly about 27 to 33 wt %, for example, about 30 wt % based on the total weight of the mixed fiber of 100 wt %. When the content is less than about 20 wt %, the formability may be degraded. Meanwhile, when the content is greater than about 40 wt %, it may be difficult to make a product.

When mixing the microfiber polyethylene terephthalate (PET) with the low viscosity polyethylene terephthalate (LM PET), the proportion of the microfiber polyethylene terephthalate (PET) may be excessive. Thus, a mix weight ratio may be about 55:40 to 75:20, about 60:35 to 70:25, or particularly about 65:30. When the contents are out of this ratio, physical properties such as the sound absorbing performance may be degraded.

The hollow staple fiber (hereinafter, referred to as conjugate fiber) may be synthetic fiber conjugated with the polyester staple fiber. The hollow staple fiber may be used as a filler of a cushion, a mattress, furniture or the like. The hollow staple fiber may have excellent bulkiness and elasticity, be light in weight, and have good heat retention, due to a stereoscopic crimp of a 3D structure that is formed of different kind of polymers and a hollow shape in which a section of the above-described fiber is not filled. The hollow staple fiber generally includes a hollow shape having a doughnut-shaped section, and may have greater elastic recovery force than general polyester. When the sound absorbing material for the vehicle is manufactured to include the hollow staple fiber, the elastic recovery force for causing the material to return to its original shape may be improved even if a certain pressure is applied thereto, and the sound absorbing performance may also be improved.

The hollow staple fiber may have the fineness of about 13 to 17 denier, or particularly of about 14 to 16 denier, and have the hollow diameter of about 38 to 43 μm. The content of the hollow staple fiber may be about 1 to 20 wt %, about 2 to 10 wt %, or particularly about 3 to 7 wt %, for example about 5 wt % in the total weight of the mixed fiber. When the content is out of this range, the sound absorbing performance and the restoring force (durability) may be degraded.

The mix weight ratio of the microfiber polyethylene terephthalate (PET), the low-melt polyethylene terephthalate (LM PET), and the hollow staple fiber may be about 10:5:1 to 15:7:1, or particularly about 13:6:1. When the contents are out of this ratio, the sound absorbing performance and the restoring force (durability) may be degraded.

In order to improve the bulkiness of the sound absorbing material for the vehicle, the microfiber polyethylene terephthalate (PET) staple fiber and the low-melt polyethylene terephthalate (LM PET) staple fiber may be mixed with the hollow staple fiber, so that the sound absorbing material having excellent bulkiness, reduced weight, and good heat retention may be manufactured or obtained. Furthermore, the material may high elastic recovery force, so that it may have excellent restoring force to return to its original shape even if a certain pressure is applied thereto. For example, the melting point of the staple fiber made by mixing the microfiber polyethylene terephthalate (PET), the low-melt polyethylene terephthalate (LM PET) and the hollow staple fiber in a predetermined ratio may range from about 240° C. to about 250° C. Since the melting point of this material is greater than the melting point (e.g., 165° C.) of the polypropylene (PP) fiber used as the conventional sound absorbing material for the vehicle, the sound absorbing material for the vehicle having excellent physical properties such as heat resistance, tensile strength, or wear resistance may be manufactured.

At step (b), the term “carding” as used herein refers to a process of forming a thin web by combing mixed fiber assemblies so that they are uniformly arranged parallel to each other. The carding method is not limited to a specific method, but the carding method known to those skilled in the art, for example, a roller card, a flat card, and a union card may be used. While a plurality of rollers 22 is arranged in a machine direction by a wire of the carding machine, the mixed fiber assemblies may be connected to each other to have the shape of a web of a thin film. For example, fibers that are supplied to the carding machine and then mixed may pass through the rollers 22 to be combed (carded), and a plurality of thin webs may be formed on a sheet having a predetermined weight. While the mixed fibers pass through the rollers 22, impurities of the fibers may be removed by spikes 24 attached to the rollers 22, and fibers agglomerated or tangled may be separated and aligned.

At step (c), the webs may be stacked to reach a target weight of a product that is finally formed. The webs are large in volume but are very low in density. Thus, when the webs are attached without any additional process, the sound absorbing material that is finally formed may be too thin. Therefore, a process of cross lapping the webs to reach the target weight of the sound absorbing material that is finally formed is required. The webs may be stacked in one direction or be stacked in a direction in which the webs are perpendicular to each other, if necessary. The optimum weight of the sound absorbing material may be about 470 to 550 g/m², about 485 to 535 g/m², or particularly about 500 to 520 g/m². A weight ranging from about 200 g/m² to about 1500 g/m² is possible depending on sound absorbing requirements.

At step (d), the needle punching is a process of physically coupling a plurality of web fibers by pressurizing the surface of the web to a predetermined depth using a needle. This process may improve a binding force between staple fibers forming the web. The needle punching converts a 2D web arrangement into a 3D web arrangement by repeatedly moving a down stripper 52 in which a plurality of needles is closely installed in a vertical direction, an inclined direction or both directions of the web layer, thus improving the binding force between the fibers. In consideration of the coupling force, surface smoothness, or physical properties of a final product, the needle may be punched with a suitable stroke number.

The needle punching may preferably be performed twice. Thus, the binding force between the web fibers may be further improved, and a deviation between left and right sides of the web may be reduced. For example, by primarily performing pre-punching of pressurizing the fibers of the web with a relatively weak force to couple the fibers to each other, subsequent secondary needle punching (main punching) may be smoothly performed. The primary needle punching may pressurize the down stripper 52 including the plurality of needles with a certain force in a direction perpendicular to the surface of the web layer, thus coupling a plurality of webs with each other. The surface of the web that is subjected to the primary needle punching may be pressurized with a relatively strong force, thus forming non-woven felt. The secondary needle punching is a main punching process, which may pressurize the surface of the web layer with a relatively stronger force than the primary needle punching to strongly couple the webs to each other. The secondary needle punching process may use two or more down strippers 62. The secondary needle punching may pressurize a plurality of down strippers with a certain force in a direction perpendicular to the surfaces of the weakly coupled webs once more, thus additionally coupling the webs to each other and thereby manufacturing the non-woven felt.

As the needle stroke number of the needle punching process increases, the bulkiness and the sound absorbing performance may be degraded. Thus, it is relatively preferable that the needle stroke number be small. For example, the needle punching process may use a needle of about 22 to 28 mm, and the needle stroke number may be about 5 to 20 ea/cm² (PPSC; punching per square centimetre), about 10 to 15 ea/cm² (PPSC), or particularly about 12 to 14 ea/cm² (PPSC). Meanwhile, when manufacturing a material applied to other vehicle components to which the sound absorbing material is not applied, the stroke number of the needle punching may be about 250 to 450 ea/cm² (PPSC), or particularly about 300 to 400 ea/cm² (PPSC).

If necessary, a step of drying the felt may be further included. The drying step may dry the felt by the common drying method, for example, hot-air drying, circulation drying, UV drying, etc. Thereafter, a forming step may be performed, so that the final product, namely, the sound absorbing material for the vehicle may be manufactured. If necessary, after the felt is formed in the shape of a desired final product, the drying process may be performed.

Table 1 is a table in which the sound absorbing material is classified into types A, B, and C according to its type. Table 2 shows required values of sound absorbing performance of types A, B, and C for the frequency. They are diagrams.

TABLE 1

| Type | Sound absorbing material |
|---|---|
| type A | FELT, glass wool or polyurethane (PU) foam |
| type B | Aramid fiber and epoxy resin binder |
| type C | PET microfiber and PET skin non-woven fabric |

TABLE 2

| | Frequency | Type A | Type B | Type C |
|---|---|---|---|---|
| Sound | 1,000 Hz | 0.35 or | 0.12 or | 0.95 or |
| absorptivity | | greater | greater | greater |
| | 2,000 Hz | 0.70 or | 0.26 or | 1.05 or |
| | | greater | greater | greater |
| | 3,150 Hz | 0.80 or | 0.45 or | 0.92 or |
| | | greater | greater | greater |
| | 5,000 Hz | 0.80 or | 0.63 or | 0.87 or |
| | | greater | greater | greater |

As shown in Tables 1 and 2, performance varies depending on the type of the sound absorbing material. The sound absorbing material manufactured by the carding-needle punching process according to an exemplary embodiment of the present invention may be classified as FELT in type A. However, when the sound absorbing material for the vehicle is manufactured in the carding-needle punching process after mixing conjugate fiber with polyethylene terephthalate (PET, see type C) according to an exemplary embodiment of the present invention, this material may have sound absorbing performance that is more excellent than the sound absorbing performance of the sound absorbing material (type C) manufactured in the melt-blown process using the PET microfiber material.

### Example

Hereinafter, examples of the present invention and comparative examples will be described in detail.

### Example 1

The microfiber polyethylene terephthalate (PET), the low viscosity polyethylene terephthalate (LM PET), and the conjugate (conju) fiber were mixed with each other in a fiber blend ratio (weight ratio) of 13:6:1. Toray 0.5 D fiber was used as the microfiber polyethylene terephthalate (PET), Toray LM 2D was used as the low viscosity polyethylene terephthalate (LM PET), and the conjugate fiber used Huvis CONJU.

After the mixed fibers were opened, the web was formed using the carding machine. Subsequently, after the web was subjected to the cross lapping process to reach a target weight, the needle punching process was performed to attach and form the cross lapped webs in a desired shape, thus manufacturing the sound absorbing material. The needle punching process formed a strong coupling by performing the primary punching and thereafter the secondary punching. The weight percent and weight ratio of fibers are shown in Table 3.

### Comparative Example 1

The method of manufacturing the sound absorbing material according to comparative example 1 is the same as the method of example 1, except that the microfiber polyethylene terephthalate (PET), the low viscosity polyethylene terephthalate (LM PET), and the conjugate fiber were mixed with each other in the fiber blend ratio (weight ratio) of 5:3:2. The weight percent and weight ratio of fibers are shown in Table 3.

TABLE 3

| | Microfiber | | | | |
|---|---|---|---|---|---|
| | polyethyl- | Low viscosity | | | |
| | ene tere- | polyethylene | Conjugate | | |
| | phthalate | terephthalate | fiber | Weight | Weight |
| | (wt %) | (wt %) | (wt %) | ratio | (g/m²) |
| Example 1 | 65 | 30 | 5 | 13:6:1 | 495 |
| Comparative | 50 | 30 | 20 | 5:3:2 | 490 |
| example 1 | | | | | |

### Comparative Example 2

The melt-blown polyethylene terephthalate (PET) and the PET staple fiber were mixed with each other in the fiber blend ratio (weight ratio) of 13:7 (a total weight is 500 g/m²). The mixed fibers manufactured the sound absorbing material (non-woven fabric) through the common blown process.

Evaluation Item 1: Sound Absorbing Performance

Table 4 shows the result of an experiment in sound absorbing performance of the sound absorbing material according to example 1 and comparative examples 1 and 2. The sound absorbing performance was evaluated as follows: a specimen having the size of 1 m×1.2 m was put into a small reverberation chamber, 15 sound sources of 400 Hz to 10,000 Hz were input, and the sound absorptivity of each material for the reverberation was measured. The results of Table 4 were obtained by averaging the results of experiments in sound absorbing performance that are performed a total of five times.

TABLE 4

| Frequency | | Comparative | Comparative |
|---|---|---|---|
| (Hz) | Example | Example 1 | Example 2 |
| 400 | 0.198 | 0.264 | — |
| 500 | 0.446 | 0.489 | |
| 630 | 0.547 | 0.521 | |
| 800 | 0.772 | 0.740 | |
| 1000 | 0.978 | 0.90 | 0.95 |
| 1250 | 0.991 | 0.895 | — |
| 1600 | 1.04 | 0.982 | |
| 2000 | 1.13 | 0.92 | 1.05 |
| 2500 | 1.17 | 0.959 | |
| 3150 | 1.12 | 1.00 | 0.92 |
| 4000 | 1.11 | 0.988 | |
| 5000 | 1.1 | 1.06 | 0.87 |
| 6300 | 1.05 | 1.07 | — |
| 8000 | 0.998 | 1.14 | |
| 10000 | 0.849 | 1.22 | |

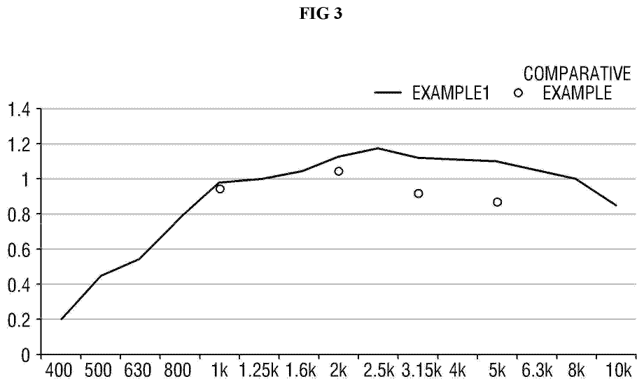

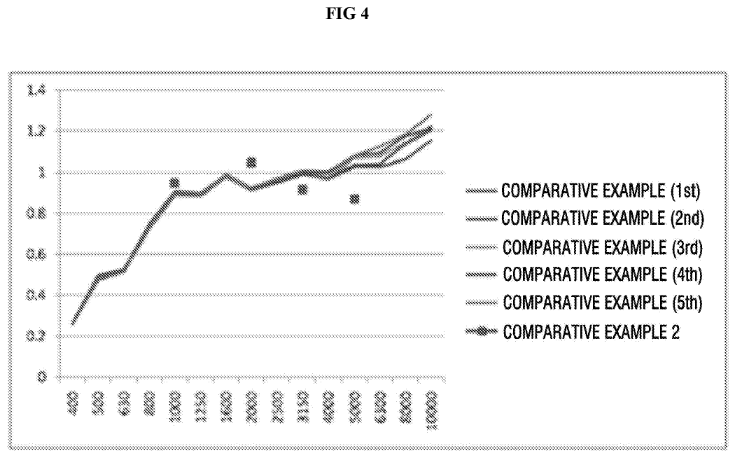

FIG. 3 illustrates the result values of sound absorption of example 1 and comparative example 2 according to a frequency. FIG. 4 illustrates the result values of sound absorption of comparative example 1 and comparative example 2 according to a frequency. As shown in Table 4 and FIGS. 3 and 4, the sound absorbing performance of example 1 was more excellent than that of the comparative example 2 in an entire range, and the sound absorbing performance of comparative example 1 was less than that of comparative example 2 in a low-frequency range of about 1000 to 2000 Hz.

Evaluation Item 2: Tensile Strength

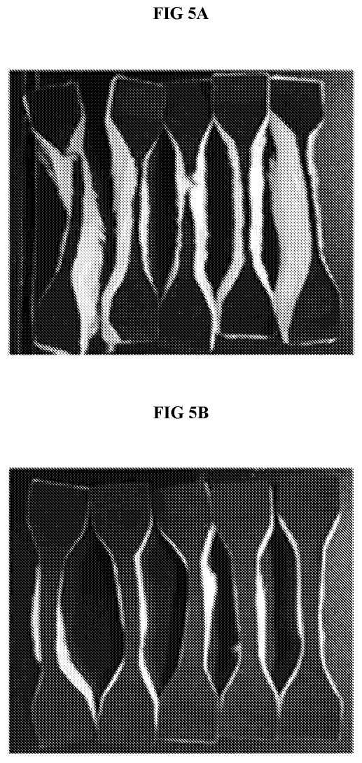

Table 5 shows tensile strength values for a cross machine direction (CD) and a machine direction (MD) of example 1 and comparative example 2. The tensile strength (MPa) was measured using a specimen of a dumbbell type 1 under the conditions of the tension speed of 200 mm/min and the load of 0.1 MPa or greater. FIG. 5A illustrates a real photograph of comparative example 2, and FIG. 5B illustrates a real photograph of example 1. As shown Table 5 and FIG. 5, the tensile strength of example 1 was greater excellent than the tensile strength of comparative example 2.

TABLE 5

| | | | Comparative |
|---|---|---|---|
| | Direction | Example 1 | Example 2 |
| Tensile Strength | CD | 0.95 | 0.2 |
| (MPa) | MD | 0.57 | 0.3 |

Evaluation Item 3: Heat Resistance

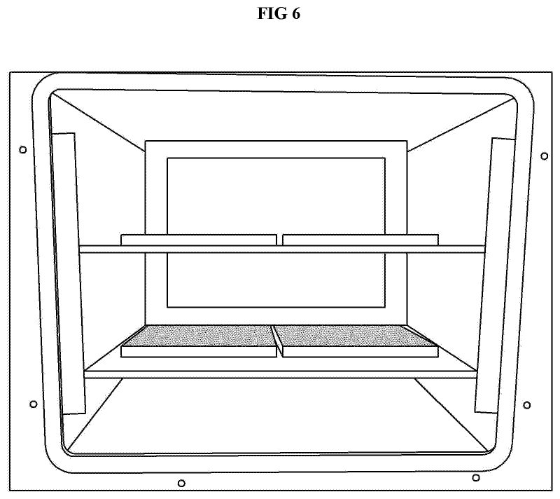

Tables 6 and 7 show the heat-resistance evaluation results of example 1 and comparative example 2. The heat resistance was evaluated as follows: the specimen having the size of 220 mm×220 mm was left for 200 hours at a temperature of 150° C., and then the thermal shrinkage in the machine direction of the sound absorbing material was measured. The heat-resistance evaluation was performed twice. FIG. 6 is a photograph capturing a process of evaluating heat resistance of example 1 and comparative example 2. As shown in Table 6, there was little deformation because the average shrinkage of example 1 was 0.5%.

TABLE 6

| Example 1 | First | Second | Average |
|---|---|---|---|
| MD(%) | 0.5 | 0.5 | 0.5 |
| CD(%) | 0.5 | 0.5 | 0.5 |

TABLE 7

| Comparative Example 2 | First | Second | Average |
|---|---|---|---|
| MD(%) | 3.0 | 3.4 | 2.7 |
| CD(%) | 2.6 | 2.8 | 2.5 |

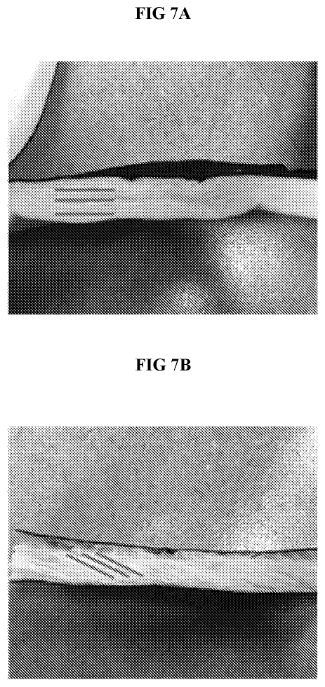

FIG. 7A illustrates a section of example 1, and FIG. 7B illustrates a section of comparative example 2. As shown in FIGS. 7A and 7B, the section A of example 1 was arranged and formed in a horizontal direction, and the section of comparative example 2 was arranged and formed in a diagonal direction.

Evaluation Item 4: Sound Absorbing Performance when being Attached to Vehicle

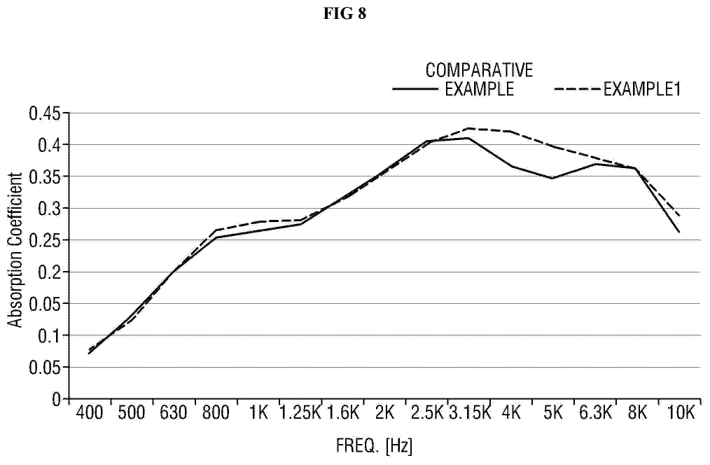

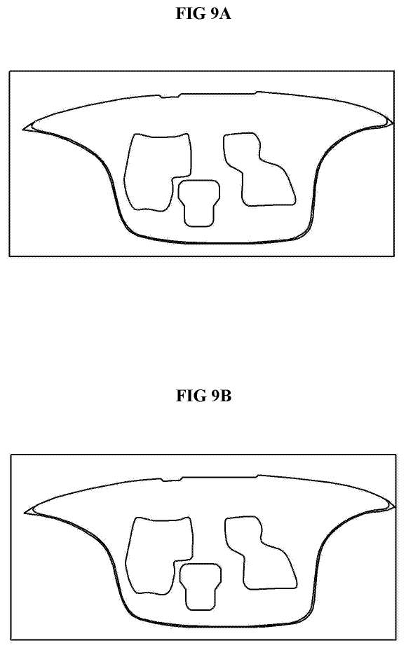

Table 8 shows the result when measuring the sound absorbing performance according to a frequency after attaching the sound absorbing materials of example 1 and comparative example 2 to the vehicle. FIG. 8 is a graph illustrating the result of Table 8, FIG. 9A is a photograph illustrating an vehicle component to which the sound absorbing material of example 1 is actually mounted, and FIG. 9B is a photograph illustrating an vehicle component to which the sound absorbing material of comparative example 2 is actually mounted.

TABLE 8

| Frequency | | Comparative |
|---|---|---|
| (Hz) | Example 1 | Example 2 |
| 400 | 0.077 | 0.072 |
| 500 | 0.124 | 0.131 |
| 630 | 0.203 | 0.204 |
| 800 | 0.265 | 0.254 |
| 1000 | 0.279 | 0.264 |
| 1250 | 0.282 | 0.274 |
| 1600 | 0.313 | 0.313 |
| 2000 | 0.357 | 0.359 |
| 2500 | 0.399 | 0.405 |
| 3150 | 0.425 | 0.411 |
| 4000 | 0.420 | 0.367 |
| 5000 | 0.397 | 0.348 |
| 6300 | 0.380 | 0.369 |
| 8000 | 0.359 | 0.362 |
| 10000 | 0.288 | 0.264 |

As shown in Table 8 and FIG. 8, the sound absorbing performance of the sound absorbing material of example 1 was similar to the sound absorbing performance of the sound absorbing material of comparative example 2, but the sound absorbing performance of the sound absorbing material of example 1 was more excellent than the sound absorbing performance of the sound absorbing material of comparative example 2 at the frequencies of 1,000, 2,000, 3,150, and 5,000 Hz.

According to exemplary embodiments of the present invention, sound absorbing performance may be improved and shape stability may be secured by optimizing the mixing ratio of mixed fibers. Furthermore, durability may be maintained even if the sound absorbing material is kept at a high temperature (e.g., 150° C.) for a long time (e.g., 200 hours). Moreover, the durability of the component may be improved due to an increase in tensile strength, and it is advantageous to recycling because it is a 100% PET product.

Although the present invention was described with reference to various exemplary embodiments shown in the drawings, it is apparent to those skilled in the art that the present invention may be changed and modified in various ways without departing from the scope of the present invention, which is described in the following claims. Therefore, the scope of the present invention is not limited to the above-described embodiment, but embraces all changes or modifications without departing from the following claims and equivalences thereof.

What is claimed is:

1. A method of manufacturing a sound absorbing material for a vehicle, comprising steps of:
preparing a mixed fiber comprising an amount of about 55 to 75 wt % of a microfiber polyethylene terephthalate (PET) staple fiber having a fineness of about 0.3 to 0.7 denier (D), an amount of about 20 to 40 wt % of a low-melt polyethylene terephthalate (LM PET) staple fiber having a fineness of about 1 to 3 denier and a melting point of about 100 to 110° C., and an amount of about 1 to 20 wt % of a hollow staple fiber having a fineness of about 13 to 17 denier and a diameter of about 38 to 43 μm, wherein the wt % is based on the total weight of the mixed fiber.

2. The method of claim 1 further comprising (i)) forming a plurality of webs comprising the mixed fiber; and (ii) forming a web layer comprising the plurality of webs.

3. The method of claim 2 further comprising (iii) forming a non-woven felt comprising the web layer.

4. A method of manufacturing a sound absorbing material for an vehicle, comprising steps of:
(a) preparing a mixed fiber comprising an amount of about 55 to 75 wt % of a microfiber polyethylene terephthalate (PET) staple fiber having a fineness of about 0.3 to 0.7 denier (D), an amount of about 20 to 40 wt % of a low-melt polyethylene terephthalate (LM PET) staple fiber having a fineness of about 1 to 3 denier and a melting point of about 100 to 110° C., and an amount of about 1 to 20 wt % of a hollow staple fiber having a fineness of about 13 to 17 denier and a diameter of about 38 to 43 μm, wherein the wt % is based on the total weight of the mixed fiber;
(b) forming a plurality of webs by carding the mixed fiber;
(c) forming a web layer by stacking a plurality of webs; and
(d) forming a non-woven felt by needle punching the web layer.

5. The method of claim 1, wherein a weight ratio of the microfiber polyethylene terephthalate (PET), the low-melt polyethylene terephthalate (LM PET), and the hollow staple fiber is about 10:5:1 to 15:7:1.

6. The method of claim 4, wherein a weight ratio of the microfiber polyethylene terephthalate (PET), the low-melt polyethylene terephthalate (LM PET), and the hollow staple fiber is about 10:5:1 to 15:7:1.

7. The method of claim 1, wherein a melting point of the mixed fiber ranges from about 240° C. to about 250° C.

8. The method of claim 4, wherein a melting point of the mixed fiber ranges from about 240° C. to about 250° C.

9. The method of claim 4, wherein the step (c) comprises a first needle punching and a second needle punching, and
wherein a pressure in the second needle punching is greater than a pressure in the first needle punching.

10. The method of claim 4, wherein a stroke number of the needle punching ranges from about 5 ea/cm² to 20 ea/cm² (PPSC) (punching per square centimetre).

11. A non-woven felt comprising the web layer obtained from the method of claim 3.

12. A vehicle comprising the non-woven felt of claim 11.
